(19) United States
(12) Patent Application Publication
(10) Pub. No.: US 2024/0427050 A1
(43) Pub. Date: Dec. 26, 2024

(54) Identification of Borehole Flow Members

(71) Applicant: Saudi Arabian Oil Company, Dhahran (SA)

(72) Inventors: Ali Jasim A Al Solial, Dhahran (SA); Mohammed Fuad Alzayer, Dhahran (SA)

(21) Appl. No.: 18/337,822

(22) Filed: Jun. 20, 2023

(51) Int. Cl. G01V 3/20; E21B 47/002; E21B 49/00

(52) U.S. Cl. CPC G01V 3/20; E21B 47/002; E21B 49/005

(57) ABSTRACT

Example computer-implemented methods, media, and systems for identification of borehole flow members are disclosed. One example computer-implemented method includes receiving a resistivity image of an earth formation surrounding a borehole. Multiple flow members in the earth formation surrounding the borehole are identified based on the resistivity image. The identified multiple flow members are provided for well completion or sampling of the borehole.

### TECHNICAL FIELD

The present disclosure relates to computer-implemented methods, media, and systems for identification of borehole flow members.

### BACKGROUND

Data collected from earth formation testing of boreholes can be used to guide well completion and sampling, but formation testing may be challenging for some boreholes due to the orientations, for example, high angles, of the boreholes.

### SUMMARY

The present disclosure involves computer-implemented methods, media, and systems for identification of borehole flow members. One example computer-implemented method includes receiving a resistivity image of an earth formation surrounding a borehole. Multiple flow members in the earth formation surrounding the borehole are identified based on the resistivity image. The identified multiple flow members are provided for well completion or sampling of the borehole.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, identifying the plurality of flow members involves generating, using a cutoff value for the resistivity image, a contrast-enhanced resistivity image for the resistivity image; and identifying, based on the contrast-enhanced resistivity image, the plurality of flow members in the earth formation surrounding the borehole.

In some implementations, identifying the plurality of flow members involves generating, using a cutoff value for the resistivity image, a contrast-enhanced resistivity image for the resistivity image; and identifying, based on the contrast-enhanced resistivity image, the plurality of flow members in the earth formation surrounding the borehole.

In some implementations, generating the contrast-enhanced resistivity image for the resistivity image involves determining the cutoff value for the resistivity image; and generating, based on the determined cutoff value, the contrast-enhanced resistivity image for the resistivity image.

In some implementations, determining the cutoff value for the resistivity image involves determining, using mud property data of the earth formation surrounding the borehole, the cutoff value for the resistivity image.

In some implementations, identifying, based on the contrast-enhanced resistivity image, the plurality of flow members involves generating a respective reservoir quality index (RQI) of the contrast-enhanced resistivity image at each of a plurality of depths of the contrast-enhanced resistivity image; and identifying, based on the generated plurality of RQIs, the plurality of flow members in the earth formation surrounding the borehole.

In some implementations, generating the respective RQI of the contrast-enhanced resistivity image at each of the plurality of depths of the contrast-enhanced resistivity image involves determining, as the respective RQI, a value of (RE_image_mean-RE_cutoff)/RE cutoff, and where RE_image_mean is equal to a mean intensity of all pixels at each of the plurality of depths of the contrast-enhanced resistivity image, and RE_cutoff is equal to the cutoff value.

In some implementations, generating, based on the determined cutoff value, the contrast-enhanced resistivity image for the resistivity image involves determining, for each pixel of the resistivity image, a value of (RE_image-RE_cutoff)/RE_cutoff, where RE_image is equal to an image intensity of the pixel of the resistivity image, and RE_cutoff is equal to the cutoff value.

In some implementations, determining the cutoff value for the resistivity image involves receiving formation testing data and formation sampling data from a plurality of boreholes; and updating, using a machine learning model and based on the received formation testing data and formation sampling data, the cutoff value for the resistivity image.

In some implementations, providing the identified plurality of flow members for well completion or sampling of the borehole involves determining, based on the identified plurality of flow members, one or more directions of perforation in the earth formation surrounding the borehole; and providing the determined one or more directions of perforation for well completion of the borehole.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example process for identifying flow members in earth formation surrounding a borehole, according to some implementations.

FIG. 2 illustrates an example process for predicting permeability of a borehole based on data from multiple boreholes and using machine learning, according to some implementations.

FIG. 3 illustrates example images and flags described in the example process of FIG. 1, according to some implementations.

FIG. 4 illustrates an example workflow for adding additional flags for well completion and sampling, according to some implementations.

FIG. 5 illustrates an example process for identifying borehole flow members, according to some implementations.

FIG. 6 is a schematic illustration of example computer systems that can be used to execute implementations of the present disclosure.

FIG. 7 illustrates an example rig system for perforation in a borehole, according to some implementations.

FIG. 8 illustrates hydrocarbon production operations that include both one or more field operations and one or more computational operations, which exchange information and control exploration for the production of hydrocarbons, according to some implementations.

Like reference numbers and designations in the various drawings indicate like elements.

### DETAILED DESCRIPTION

This disclosure relates to systems and methods for identification of borehole flow members. A borehole flow member can be a pore cluster, a fracture, or a conductive fault in the earth formation surrounding a borehole. In one embodiment, an imaging system generates resistivity image logs of a borehole using a resistivity imaging tool. The resistivity imaging tool sends electrical current to the earth formation surrounding the borehole and measures the conductivity of the earth formation. The earth formation surrounding the borehole is the exposed part of earth layers facing the borehole opening, and the measured conductivity of the earth formation can be the measured conductivity of the borehole wall. Then, the resistivity imaging tool converts the conductivity into resistivity through the inverse of conductivity. The imaging system can then display the resistivity of the earth formation surrounding the borehole as a resistivity image. The imaging system can perform this process through multiple caliper arms that cover the earth formation from different directions with the azimuth of each resistivity reading being recorded as part of an array data set. The imaging system can use the array data set to display a resistivity image of the earth formation surrounding the borehole. The imaging system can also perform operations on the array data set. Parameters of the array data set can include depth, resistivity, and azimuth of each data point in the array data set, as well as the pad number of the resistivity imaging tool used to generate the array data set.

Resistivity measurements can vary based on the amount of conductive fluid saturating the pores in the earth formation surrounding the borehole. Resistivity image measurements have the characteristics of being shallow and focused, and consequently the measurements cover mostly invaded zones that are close to the borehole wall in which some or all of the moveable fluids have been displaced by mud filtrate. This creates the contrast in resistivity of the earth formation, which enables an imaging system to identify which pores have displaced fluid and which pores do not have displaced fluid.

The measured resistivity can also be used for pore classification. Here, the imaging system converts the measured resistivity to a permeability that represents the mobility to saturating fluid. For example, low resistivity areas can indicate either clay saturated pores or pores with original reservoir formation water. High resistivity reading can indicate a lack of continuous pore presence or a lack of a continuous water phase within the porous space. An example of high resistivity areas includes earth formation areas with bitumen coating.

In some implementations, the imaging system can apply pre-determined cutoff values to the resistivity image to enhance the contrast of the image, and thus, enhance the visibility of the flow members and continuities in the displayed image. Flags associated with pore classification can also be provided to end-users to aid their decision-making in well completion and sampling. Additionally, the imaging system can use a pore-count and a machine learning algorithm to convert the resistivity image into permeability and mobility data points.

The disclosed methods and systems provide many advantages over existing systems. Some existing methods and systems for identifying flow members segment images of individual wells geologically to differentiate between sand and shale in the overall borehole. This is usually done with other well log measurements or even visually by identifying dark versus light overall trends in the segment images. In contrast, the disclosed methods and systems process high resolution resistivity image data taken at a particular time in a consistent way to identify and classify productive hydrocarbon zones. The disclosed methods and systems can also guide decisions about perforation directions in complex formations surrounding a borehole. Additionally, the disclosed methods can work in complex sand environments where basic well log measurements may not differentiate between productive and non-productive zones.

The disclosed methods and systems can replace formation testing as a tool for measuring permeability for the entire reservoir interval. Additionally, the disclosed methods and systems can characterize thinly bedded formations that are beyond the resolution of traditional well logs. The disclosed methods and systems can also identify flow members in high angle or horizontal wells where formation testing data can be difficult to acquire. Moreover, the cost associated with the disclosed methods and systems is much lower than the cost associated with formation testing that covers long laterals, for example, a lateral with hundreds of pressure points.

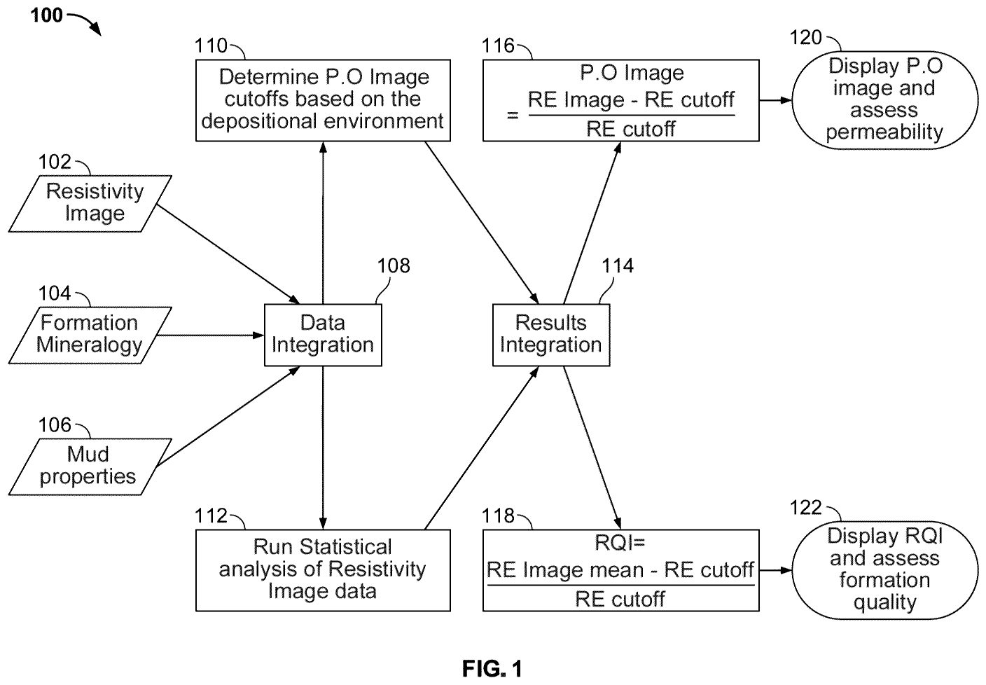

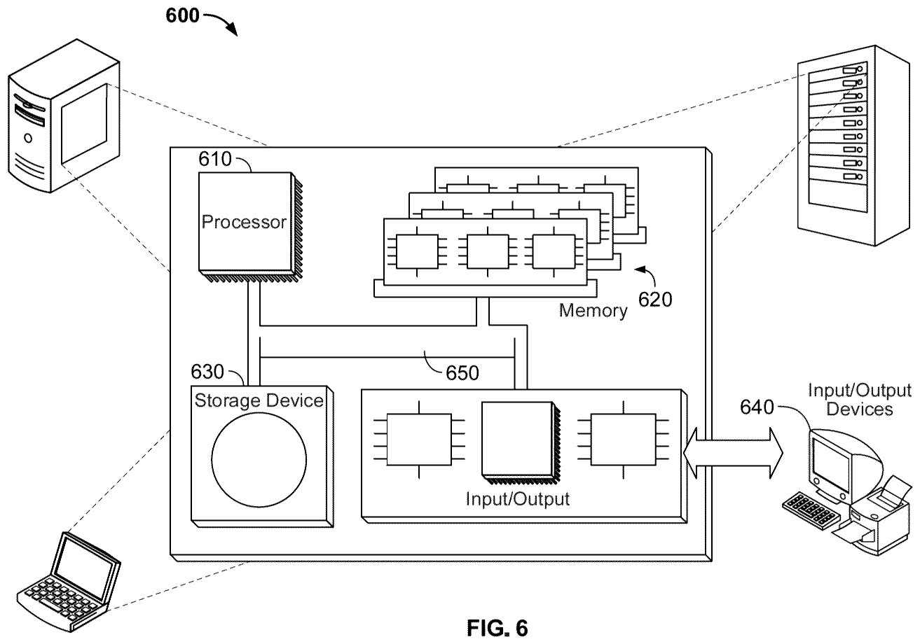

FIG. 1 illustrates an example process 100 for identifying flow members in an earth formation surrounding a borehole. For convenience, process 100 will be described as being performed by a computer system having one or more computers located in one or more locations and programmed appropriately in accordance with this specification. An example of the computer system is the computing system 600 illustrated in FIG. 6 and described later.

The process 100 starts at step 108. At this step, the computer system integrates resistivity image data 102, formation mineralogy data 104, and mud property data 106 as input data to step 110 and step 112.

At step 110, the computer system determines a cutoff value used to generate orientation image from resistivity image data 102, e.g., based on formation mineralogy data 104 and mud property data 106. The cutoff value is a resistivity value that can be used to process resistivity image data 102 in order to determine where flow members with displaced fluid are in resistivity image data 102. The cutoff value can depend on the composition of the earth formation surrounding the borehole, for example, lithology, grain size, and saturation of the earth formation. The composition of the earth formation can be determined from formation mineralogy data 104. Formation mineralogy data 104 can also be used to determine the earth formation's clay nature. Clay information determined from formation mineralogy data 104 can be used to model the effect of the clays on the resistivity response.

Additionally, the presence of certain minerals, such as siderite and anhydrite, in the earth formation can cause resistivity to trend upwards. Siderite is a mineral composed of iron carbonate. It can occur in thin beds with shales, clay, or coal seams as sedimentary deposits and in hydrothermal metallic veins as waste rock. Anhydrite is one of the minerals in evaporite deposits and can occur with salt deposits in association with gypsum. Earth formation with anhydrite can be more marine inclined in terms of deposition and can show higher resistivity values when compared to earth formation without anhydrite, due to the general trends in grain and pore sizes. Therefore, a higher cutoff value for earth formation with anhydrite can be used. In some implementations, the cutoff value can also depend on the composition of mud for drilling in the borehole. The composition of mind can be determined from mud property data 106. For an earth formation composed of less than threshold sand size (e.g., 0.2 nanometer sand), with anhydrite cement, and with small presence of illite and kaolinite measured in an oil-based drilling mud (obm), an example cutoff value can be 22. If the presence of kaolinite is high, the example cutoff value can be 15.

At step 112, the computer system performs statistical analysis of resistivity image data 102 to determine statistical parameters associated with resistivity image data 102. For example, the computer system can determine the mean of resistivity image data 102 at each depth in step 112.

At step 114, the computer system integrates results from step 110 and step 112 as input data to step 116 and step 118. At step 116, the computer system generates an orientation image corresponding to resistivity image data 102 by calculating, for each pixel of resistivity image data 102, (RE image-RE cutoff)/RE cutoff. RE image represents the image intensity of a pixel in resistivity image data 102, and RE cutoff represents the cutoff value determined in step 110.

At step 118, the computer system generates a reservoir quality index (RQI) for each depth by calculating, for resistivity image data 102 at each depth, (RE image mean-RE cutoff)/RE cutoff. Here, RE image mean represents the mean intensity of all the pixels at each depth of resistivity image data 102, and RE cutoff represents the cutoff value determined in step 110.

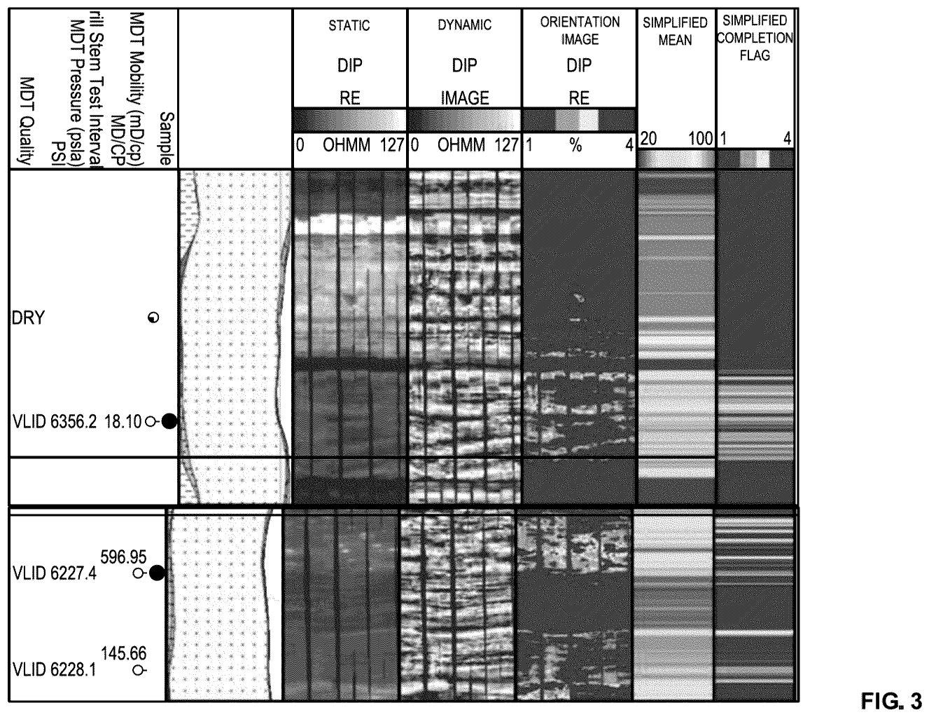

At step 120, the computer system displays the orientation image generated in step 116. Further, the computer system can assess permeability of the earth formation surrounding the borehole based on the orientation image, as described below in connection with FIG. 3.

At step 122, the computer system displays the RQI generated in step 118. Further, the computer system can assess the quality of the earth formation surrounding the borehole, as also described below in connection with FIG. 3.

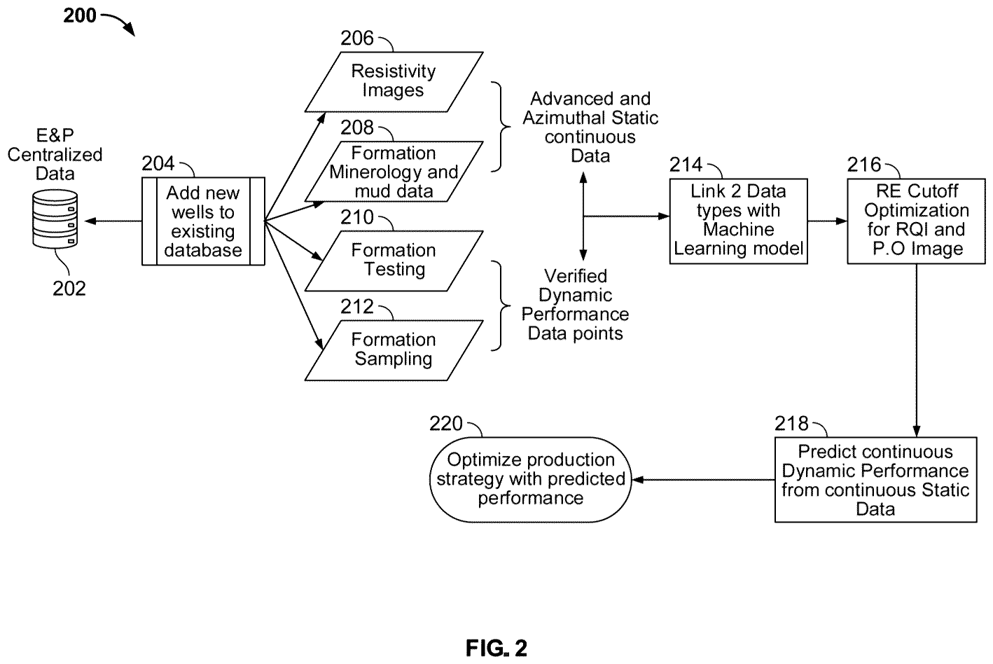

FIG. 2 illustrates an example process 200 for using machine learning to predict a permeability of a borehole based on data from multiple boreholes. In some implementations, the computer system combines data sources from the multiple boreholes to improve the prediction of permeability and other parameters of the borehole. Further, the computer system can match high-resolution formation testing data from the multiple boreholes against resistivity image data from the multiple boreholes in a machine learning model to confirm confidence and permeability of the borehole.

In some implementations, the probes of formation testing tools and the image pads of resistivity imaging tools are of similar size, and consequently the resolution of formation testing data and the resolution of resistivity image data are similar. Therefore, the computer system can use the mobility data from the formation testing tools to calibrate the image behavior for permeable layers of earth formation. Mobility can be defined as permeability or viscosity that is sensitive to mud property. Formation testing tools can pump from the earth formation by placing a probe on the formation, and the formation testing data 210 collected by the formation testing tools can include pressure, temperature, and pumping rate. Pumping rate can be used in generating mobility data. The machine learning model can use the mobility data to find the permeable layers in the resistivity image and compare the values of these layers for a trend. The trend can be a cutoff value or a certain rock property, for example, permeability of the borehole.

At step 204, the computer system adds data from new wells to an existing database. More specifically, the computer system adds resistivity image data 206 and formation mineralogy and mud data 208 from the new wells to the existing database as azimuthal continuous static data. Formation testing data 210 and formation sampling data 212 from the new wells are added to the existing database as verified continuous dynamic performance data.

At step 214, the computer system sends the azimuthal continuous static data and verified continuous dynamic performance data to a machine learning model where they are linked.

At step 216, the machine learning model refines the cutoff value generated in step 110 of FIG. 1 based on both the azimuthal continuous static data and verified continuous dynamic performance data.

At step 218, the machine learning model determines a continuous dynamic performance of the earth formation surrounding the borehole from the azimuthal continuous static data.

At step 220, the computer system determines a production strategy associated with the borehole based on the predicted continuous dynamic performance from step 218.

FIG. 3 illustrates example images and flags described in example process 100. FIG. 3 includes four sample points with different mobility values. Example resistivity image data 102 are displayed in FIG. 3 with static gain and dynamic gain respectively. Orientation image generated from the example resistivity image data 102 in step 116 is also displayed. As shown in FIG. 3, the orientation image next to the dry point shows almost no signs of permeability with little scattered signs across the orientation image. The presence and distribution of signs around the third point in the orientation image show the high mobility observed across this interval. FIG. 3 also shows the simplified mean of resistivity image data 102 that is used in step 118 to generate RQI. Simplified completion flag representing RQI generated in step 118 and displayed in step 122 is also shown in FIG. 3.

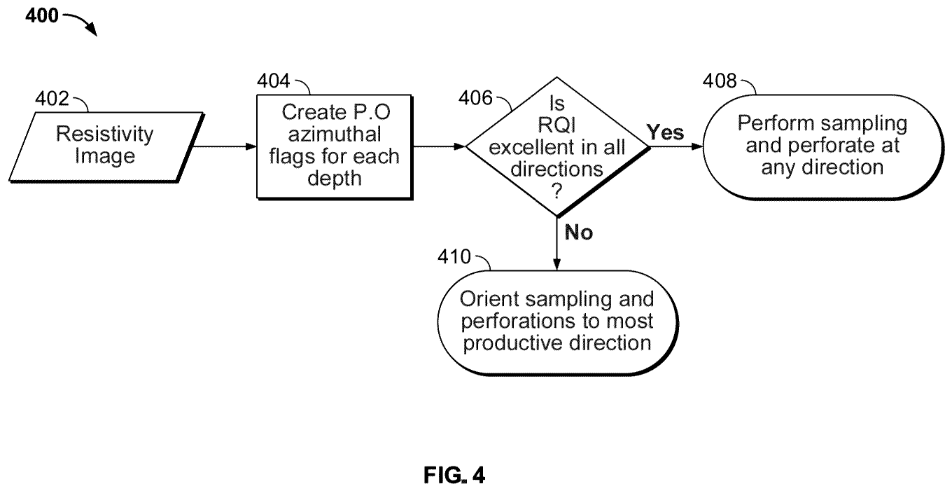

FIG. 4 illustrates an example workflow 400 for adding additional flags for well completion and sampling. As shown in FIG. 3, the behavior of completion flag for certain layers shown in FIG. 3 is unstable. Radial perforations and straddle packers can help further stabilize the completion flag.

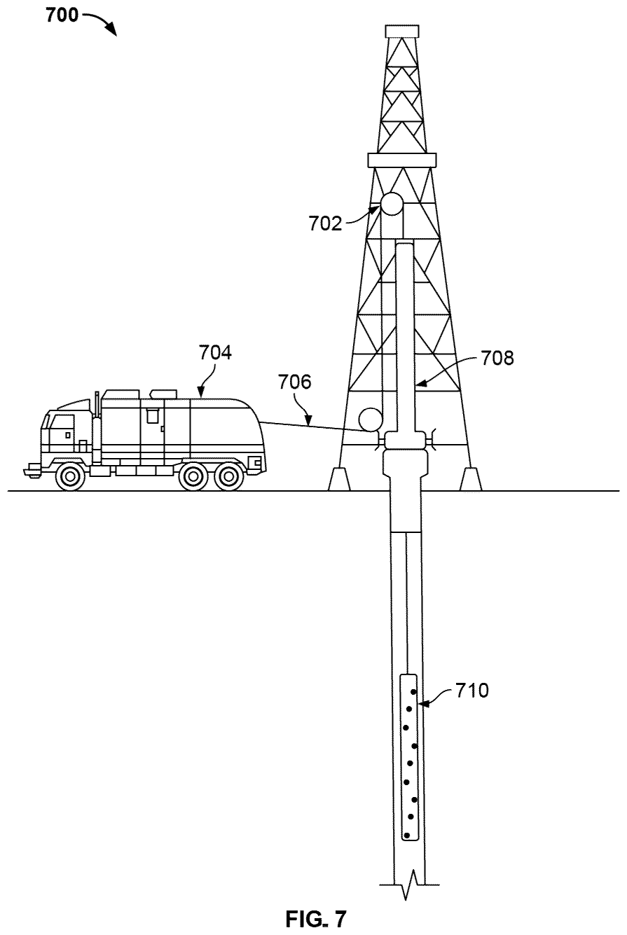

At step 404, the computer system can create azimuthal flags for each depth of resistivity image data 402, which is directional array measurement data with an azimuthal direction and depth attached to each array measurement. The computer system can use the resistivity image data 402 to generate azimuthal flags by segmenting the image represented by the resistivity image data 402. An example of the generated azimuthal flags is shown in column 2 of FIG. 3 as an orientation image. At step 406, the computer system evaluates the quality of RQI in different directions, e.g., by comparing the RQI to a predetermined threshold. If the RQI value indicates high RQI quality, for example, if the RQI value is between 2 and 2.5, sampling and perforation of the earth formation surrounding a borehole are performed in each direction in step 408. If the RQI value indicates low RQI quality, for example, if the RQI value is below 2 or above 2.5, the sampling and perforation are oriented along the most productive direction in step 410, based on the azimuthal flags created in step 404. In some implementations, as part of a well completion operation, perforation of the earth formation surrounding a borehole can be performed using a rig system that includes a gun for formation perforation and a perforating unit that controls the gun during perforation. For example, FIG. 7 illustrates an example rig system 700 for perforation in a borehole. Perforating unit 704 controls gun 710 in a borehole through cable 706 to perform perforation of the earth formation surrounding the borehole. Well head pressure control equipment 708 controls the pressure that overcomes casing in the borehole and formation strength when gun 710 is used to perforate the formation surrounding the borehole. The direction of the perforation of gun 710 is determined in steps 408 or 410 described above. Sampling of the formation surrounding the borehole can be done in a similar manner, with the direction of the sampling determined in steps 408 or 410 describe above. In some implementations, formation sampling can be part of a formation evaluation operation and involves sampling clean formation fluid free of drilling fluid filtrate contamination.

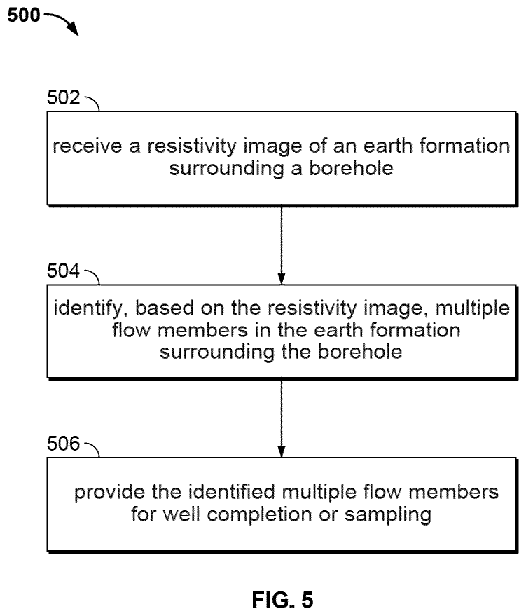

FIG. 5 illustrates an example process 500 for identifying borehole flow members. For convenience, process 500 will be described as being performed by a computer system having one or more computers located in one or more locations and programmed appropriately in accordance with this specification. An example of the computer system is the computing system 600 illustrated in FIG. 6 and described later.

At step 502, a computer system receives a resistivity image of an earth formation surrounding a borehole. At step 504, the computer system identifies, based on the resistivity image, multiple flow members in the earth formation surrounding the borehole. At step 506, the computer system provides the identified multiple flow members for well completion or sampling.

FIG. 6 illustrates a schematic diagram of an example computing system 600. The system 600 can be used for the operations described in association with the implementations described herein. For example, the system 600 may be included in the computer system discussed herein. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit. The memory 620 is a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

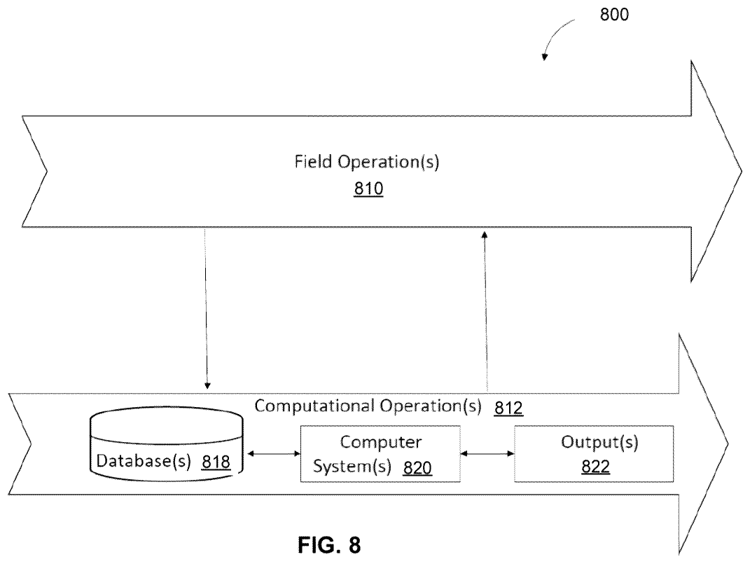

FIG. 8 illustrates hydrocarbon production operations 800 that include both one or more field operations 810 and one or more computational operations 812, which exchange information and control exploration for the production of hydrocarbons. In some implementations, outputs of techniques of the present disclosure can be performed before, during, or in combination with the hydrocarbon production operations 800, specifically, for example, either as field operations 810 or computational operations 812, or both.

Examples of field operations 810 include forming/drilling a wellbore, hydraulic fracturing, producing through the wellbore, injecting fluids (such as water) through the wellbore, to name a few. In some implementations, methods of the present disclosure can trigger or control the field operations 810. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 810 and responsively triggering the field operations 810 including, for example, generating plans and signals that provide feedback to and control physical components of the field operations 810. Alternatively or in addition, the field operations 810 can trigger the methods of the present disclosure. For example, implementing physical components (including, for example, hardware, such as sensors) deployed in the field operations 810 can generate plans and signals that can be provided as input or feedback (or both) to the methods of the present disclosure.

Examples of computational operations 812 include one or more computer systems 820 that include one or more processors and computer-readable media (e.g., non-transitory computer-readable media) operatively coupled to the one or more processors to execute computer operations to perform the methods of the present disclosure. The computational operations 812 can be implemented using one or more databases 818, which store data received from the field operations 810 and/or generated internally within the computational operations 812 (e.g., by implementing the methods of the present disclosure) or both. For example, the one or more computer systems 820 process inputs from the field operations 810 to assess conditions in the physical world, the outputs of which are stored in the databases 818. For example, seismic sensors of the field operations 810 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 812 where they are stored in the databases 818 and analyzed by the one or more computer systems 820.

In some implementations, one or more outputs 822 generated by the one or more computer systems 820 can be provided as feedback/input to the field operations 810 (either as direct input or stored in the databases 818). The field operations 810 can use the feedback/input to control physical components used to perform the field operations 810 in the real world.

For example, the computational operations 812 can process the seismic data to generate three-dimensional (3D) maps of the subsurface formation. The computational operations 812 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 812 to process new information about the formation and control the drilling to adjust to the observed conditions in real-time.

The one or more computer systems 820 can update the 3D maps of the subsurface formation as information from one exploration well is received and the computational operations 812 can adjust the location of the next exploration well based on the updated 3D maps. Similarly, the data received from production operations can be used by the computational operations 812 to control components of the production operations. For example, production well and pipeline data can be analyzed to predict slugging in pipelines leading to a refinery and the computational operations 812 can control machine operated valves upstream of the refinery to reduce the likelihood of plant disruptions that run the risk of taking the plant offline.

In some implementations of the computational operations 812, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Certain aspects of the subject matter described here can be implemented as a method. A resistivity image of an earth formation surrounding a borehole is received. Multiple flow members in the earth formation surrounding the borehole are identified based on the resistivity image. The identified multiple flow members are provided for well completion or sampling of the borehole.

An aspect taken alone or combinable with any other aspect includes the following features. Identifying the multiple flow members include generating a contrast-enhanced resistivity image for the resistivity image using a cutoff value for the resistivity image, and identifying the multiple flow members in the earth formation surrounding the borehole based on the contrast-enhanced resistivity image.

An aspect taken alone or combinable with any other aspect includes the following features. Generating the contrast-enhanced resistivity image for the resistivity image includes determining the cutoff value for the resistivity image, and generating, based on the determined cutoff value, the contrast-enhanced resistivity image for the resistivity image.

An aspect taken alone or combinable with any other aspect includes the following features. Determining the cutoff value for the resistivity image includes determining, using mud property data of the earth formation surrounding the borehole, the cutoff value for the resistivity image.

An aspect taken alone or combinable with any other aspect includes the following features. Identifying, based on the contrast-enhanced resistivity image, the multiple flow members includes generating a respective reservoir quality index (RQI) of the contrast-enhanced resistivity image at each of multiple depths of the contrast-enhanced resistivity image, and identifying, based on the generated multiple RQIs, the multiple flow members in the earth formation surrounding the borehole.

An aspect taken alone or combinable with any other aspect includes the following features. Generating the respective RQI of the contrast-enhanced resistivity image at each of the plurality of depths of the contrast-enhanced resistivity image includes determining, as the respective RQI, a value of (RE_image_mean-RE_cutoff)/RE_cutoff, where RE_image_mean is equal to a mean intensity of all pixels at each of the multiple depths of the contrast-enhanced resistivity image, and RE_cutoff is equal to the cutoff value.

An aspect taken alone or combinable with any other aspect includes the following features. Generating, based on the determined cutoff value, the contrast-enhanced resistivity image for the resistivity image includes determining, for each pixel of the resistivity image, a value of (RE_image-RE_cutoff)/RE_cutoff, where RE_image is equal to an image intensity of the pixel of the resistivity image, and RE_cutoff is equal to the cutoff value.

An aspect taken alone or combinable with any other aspect includes the following features. Determining the cutoff value for the resistivity image includes receiving formation testing data and formation sampling data from multiple boreholes, and updating, using a machine learning model and based on the received formation testing data and formation sampling data, the cutoff value for the resistivity image.

An aspect taken alone or combinable with any other aspect includes the following features. Providing the identified plurality of flow members for well completion or sampling of the borehole includes determining, based on the identified multiple flow members, one or more directions of perforation in the earth formation surrounding the borehole, and providing the determined one or more directions of perforation for well completion of the borehole.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

We claim:

1. A computer-implemented method comprising:
receiving a resistivity image of an earth formation surrounding a borehole;
identifying, based on the resistivity image, a plurality of flow members in the earth formation surrounding the borehole; and
providing the identified plurality of flow members for well completion or sampling of the borehole.

2. The computer-implemented method of claim 1, wherein identifying the plurality of flow members comprises:
generating, using a cutoff value for the resistivity image, a contrast-enhanced resistivity image for the resistivity image; and
identifying, based on the contrast-enhanced resistivity image, the plurality of flow members in the earth formation surrounding the borehole.

3. The computer-implemented method of claim 2, wherein generating the contrast-enhanced resistivity image for the resistivity image comprises:
determining the cutoff value for the resistivity image; and
generating, based on the determined cutoff value, the contrast-enhanced resistivity image for the resistivity image.

4. The computer-implemented method of claim 3, wherein determining the cutoff value for the resistivity image comprises:
determining, using mud property data of the earth formation surrounding the borehole, the cutoff value for the resistivity image.

5. The computer-implemented method of claim 2, wherein identifying, based on the contrast-enhanced resistivity image, the plurality of flow members comprises:
generating a respective reservoir quality index (RQI) of the contrast-enhanced resistivity image at each of a plurality of depths of the contrast-enhanced resistivity image; and
identifying, based on the generated plurality of RQIs, the plurality of flow members in the earth formation surrounding the borehole.

6. The computer-implemented method of claim 5, wherein generating the respective RQI of the contrast-enhanced resistivity image at each of the plurality of depths of the contrast-enhanced resistivity image comprises:
determining, as the respective RQI, a value of (RE_image_mean-RE_cutoff)/RE_cutoff, wherein RE_image_mean is equal to a mean intensity of all pixels at each of the plurality of depths of the contrast-enhanced resistivity image, and RE_cutoff is equal to the cutoff value.

7. The computer-implemented method of claim 3, wherein generating, based on the determined cutoff value, the contrast-enhanced resistivity image for the resistivity image comprises:
determining, for each pixel of the resistivity image, a value of (RE_image-RE_cutoff)/RE_cutoff, wherein RE_image is equal to an image intensity of the pixel of the resistivity image, and RE_cutoff is equal to the cutoff value.

8. The computer-implemented method of claim 3, wherein determining the cutoff value for the resistivity image comprises:
receiving formation testing data and formation sampling data from a plurality of boreholes; and
updating, using a machine learning model and based on the received formation testing data and formation sampling data, the cutoff value for the resistivity image.

9. The computer-implemented method of claim 1, wherein providing the identified plurality of flow members for well completion or sampling of the borehole comprises:
determining, based on the identified plurality of flow members, one or more directions of perforation in the earth formation surrounding the borehole; and
providing the determined one or more directions of perforation for well completion of the borehole.

10. A non-transitory computer-readable medium storing one or more instructions executable by a computer system to perform operations comprising:
receiving a resistivity image of an earth formation surrounding a borehole;
identifying, based on the resistivity image, a plurality of flow members in the earth formation surrounding the borehole; and
providing the identified plurality of flow members for well completion or sampling of the borehole.

11. The non-transitory computer-readable medium of claim 10, wherein identifying the plurality of flow members comprises:
generating, using a cutoff value for the resistivity image, a contrast-enhanced resistivity image for the resistivity image; and
identifying, based on the contrast-enhanced resistivity image, the plurality of flow members in the earth formation surrounding the borehole.

12. The non-transitory computer-readable medium of claim 11, wherein generating the contrast-enhanced resistivity image for the resistivity image comprises:
determining the cutoff value for the resistivity image; and
generating, based on the determined cutoff value, the contrast-enhanced resistivity image for the resistivity image.

13. The non-transitory computer-readable medium of claim 12, wherein determining the cutoff value for the resistivity image comprises:
determining, using mud property data of the earth formation surrounding the borehole, the cutoff value for the resistivity image.

14. The non-transitory computer-readable medium of claim 11, wherein identifying, based on the contrast-enhanced resistivity image, the plurality of flow members comprises:
generating a respective reservoir quality index (RQI) of the contrast-enhanced resistivity image at each of a plurality of depths of the contrast-enhanced resistivity image; and
identifying, based on the generated plurality of RQIs, the plurality of flow members in the earth formation surrounding the borehole.

15. The non-transitory computer-readable medium of claim 14, wherein generating the respective RQI of the contrast-enhanced resistivity image at each of the plurality of depths of the contrast-enhanced resistivity image comprises:
determining, as the respective RQI, a value of (RE_image_mean-RE_cutoff)/RE_cutoff, wherein RE_image_mean is equal to a mean intensity of all pixels at each of the plurality of depths of the contrast-enhanced resistivity image, and RE_cutoff is equal to the cutoff value.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a resistivity image of an earth formation surrounding a borehole;
identifying, based on the resistivity image, a plurality of flow members in the earth formation surrounding the borehole; and
providing the identified plurality of flow members for well completion or sampling of the borehole.

17. The computer-implemented system of claim 16, wherein identifying the plurality of flow members comprises:
generating, using a cutoff value for the resistivity image, a contrast-enhanced resistivity image for the resistivity image; and
identifying, based on the contrast-enhanced resistivity image, the plurality of flow members in the earth formation surrounding the borehole.

18. The computer-implemented system of claim 17, wherein generating the contrast-enhanced resistivity image for the resistivity image comprises:
determining the cutoff value for the resistivity image; and
generating, based on the determined cutoff value, the contrast-enhanced resistivity image for the resistivity image.

19. The computer-implemented system of claim 18, wherein determining the cutoff value for the resistivity image comprises:
determining, using mud property data of the earth formation surrounding the borehole, the cutoff value for the resistivity image.

20. The computer-implemented system of claim 17, wherein identifying, based on the contrast-enhanced resistivity image, the plurality of flow members comprises:
generating a respective reservoir quality index (RQI) of the contrast-enhanced resistivity image at each of a plurality of depths of the contrast-enhanced resistivity image; and
identifying, based on the generated plurality of RQIs, the plurality of flow members in the earth formation surrounding the borehole.
